(19) United States
(12) Patent Application Publication
(10) Pub. No.: US 2003/0202781 A1
(43) Pub. Date: Oct. 30, 2003

(54) Automotive entertainment system with digital versatile disc player and interface architecture therefor

(76) Inventors: Jiande Wu, Livonia, MI (US); Michael W. Flood, Flat Rock, MI (US); Kenneth C. Miller, Canton, MI (US); Abdallah S. El-Saghir, Dearborn Heights, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/135,635

(22) Filed: Apr. 30, 2002

(51) Int. Cl. H04N 5/781

(52) U.S. Cl. 386/125; 386/126

(57) ABSTRACT

An automotive multimedia entertainment system includes a head unit and a DVD player remote from and integrated with the head unit. Operation of the DVD player can be initiated by user interaction with the head unit. A method for interfacing a head unit with a DVD player comprises the initial step of initializing the DVD player. Next, the DVD player is monitored for communication failures and functional faults. The head unit enters a DVD normal operation mode if the DVD player is initialized and no communication failures or functional faults exist. If a communication failure or functional fault exists, the head unit enters a fault mode. If a communication failure or critical functional fault is confirmed, the DVD player enters a shutdown mode.

### BACKGROUND OF THE INVENTION

The present invention relates in general to an entertainment system for a passenger vehicle, and more specifically to a multimedia entertainment system comprising a head unit adapted to interface with an integrated digital versatile disc player provided mainly for use by rear seat passengers of the vehicle.

It is well known to provide portable, self-contained audio and video components that could be used in vehicles. Integrating audio and video components in vehicle entertainment systems is increasingly gaining popularity. Such integration provides significant advantages in terms of usability and convenience. Furthermore, performance could be improved by interconnecting the components with the vehicle entertainment system so that audio from the components could be reproduced over the vehicle entertainment system speakers.

Integrating components into the vehicle entertainment system has an associated cost. Since not all purchasers of a particular model of vehicle desire to purchase a particular component, it becomes necessary to produce vehicles with and without such a component. On the other hand, nearly all vehicles are manufactured with an entertainment system, typically including a head unit, a tuner, and at least one playback component for prerecorded media. The need to obtain distinct head units adapted to work with particular components, and different head units that are not, and the necessity to coordinate manufacture of different vehicle installations further adds to the total manufacturing cost.

To reduce the manufacturing cost associated with distinct head units, vehicle entertainment systems have been developed for interfacing head units with various components integrated in the entertainment system. However, known interface designs result in increased bus traffic and operational inefficiencies. Moreover, known head units do not interface with integrated digital versatile disc players located remotely from the head unit.

### SUMMARY OF THE INVENTION

The present invention has the advantage of providing an automotive multimedia entertainment system that is adapted to easily and efficiently interface a head unit with a digital versatile disc (DVD) player. The automotive multimedia entertainment system includes a head unit and a DVD player remote from and integrated with the head unit. Operation of the DVD player can be initiated by user interaction with the head unit. A method for interfacing a head unit with a DVD player comprises the initial step of initializing the DVD player. Next, the DVD player is monitored for communication failures and functional faults. The head unit enters a DVD normal operation mode if the DVD player is initialized and no communication failures or critical functional faults exist. If a communication failure or functional fault exists, the head unit enters a fault mode. If a communication failure or functional fault is confirmed, the DVD player enters a shutdown mode.

### BRIEF DESCRIPTION OF THE DRAWINGS

FIG. 1 is a schematic diagram showing a multimedia vehicle entertainment system with major components according to a preferred embodiment of the present invention.

FIG. 2 is a flowchart showing DVD operation modes of a head unit and a relationship between the operation modes.

FIG. 3 is a flowchart of a method by which the head unit performs a DVD initialization mode.

FIG. 4 is a flowchart showing a method by which the head unit processes faults.

FIG. 5 is a flowchart showing a method by which the head unit processes retries.

FIG. 6 is a flowchart showing a method by which the head unit processes commands to the DVD player.

### DETAILED DESCRIPTION OF PREFERRED EMBODIMENTS

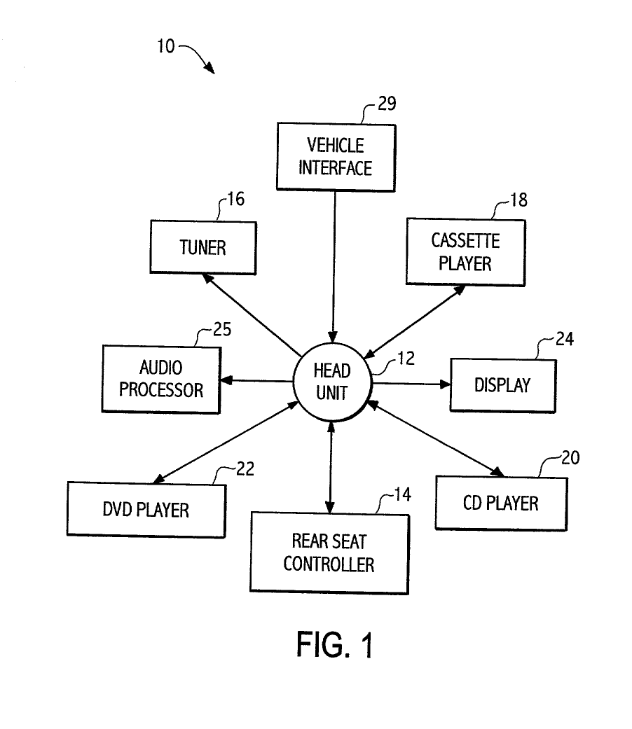

Now with reference to the drawing, wherein like numerals designate like components throughout all of the several Figures, there is illustrated in FIG. 1 an in-vehicle entertainment system 10. The entertainment system 10 may comprise a main controller or head unit 12, a rear seat controller 14, and various components, such as a tuner 16, a cassette player 18, a compact disc (CD) player 20, and a digital versatile disc (DVD) player 22, with which the head unit 12 communicates. The head unit 12 provides a display 24 for user interaction. The head unit 12 also contains an audio processor 25 for generating front and rear audio output signals for reproduction by the entertainment system 10. Some of the components shown in FIG. 1 may be integrated into with the head unit 12, (e.g., in a single multimedia unit packaged) and provided in the front instrument panel of a vehicle, including, for example, the tuner 16, the cassette player 18, the CD player 20, and the display 24. Other components may be contained in separate locations in the vehicle remote from the head unit 12, such as the DVD player 22, which may be integrated into the vehicle interior trim so as to be accessible to rear seat passengers of the vehicle.

The head unit 12 could be connected to the foregoing components through any suitable network. For example, each of the components remote from head unit 12 could be connected to the head unit 12 through a two-wire audio control protocol network (ACP). Although an ACP is preferred, other multiplex networks, such as any network conforming to SAE standard J1850 or controller area network (CAN), may be suitable for carrying out the invention.

The head unit 12 is adapted to control the foregoing components. Consequently, the head unit 12 functions as a master while the foregoing components function as slaves.

The operation of the foregoing components could be initiated by user interaction from front seat passengers of the vehicle through the bezel of the head unit 12 or the rear seat passengers through the rear seat controller 14. An example of a head unit 12 and a rear seat controller 14 are disclosed in U.S. Pat. No. 6,330,337, issued Dec. 11, 2001, to Nicholson et al. The disclosure of this patent is incorporated herein by reference.

The foregoing components can respond to valid commands sent from the head unit 12 by sending messages to the head unit 12. Some of the messages sent to the head unit 12 merely confirm that the components have received the commands while other messages provide information to the head unit 12. Some of the messages may even be in the form of text string display messages, which provide information relating to the operation of the components, for display on the display 24 of the head unit 12.

According to the present invention, there is a method for interfacing the head unit 12 and the DVD player 22. The method is adapted to be carried out by a system software interface design. In accordance with the interface design, all of the necessary interfaces between the head unit 12 and the DVD player 22 could be performed by a DVD manager software component. The DVD manager resides in the head unit 12 and will be called periodically when the vehicle ignition is turned on. The head unit 12 could be interfaced with the vehicle ignition through the vehicle interface 29.

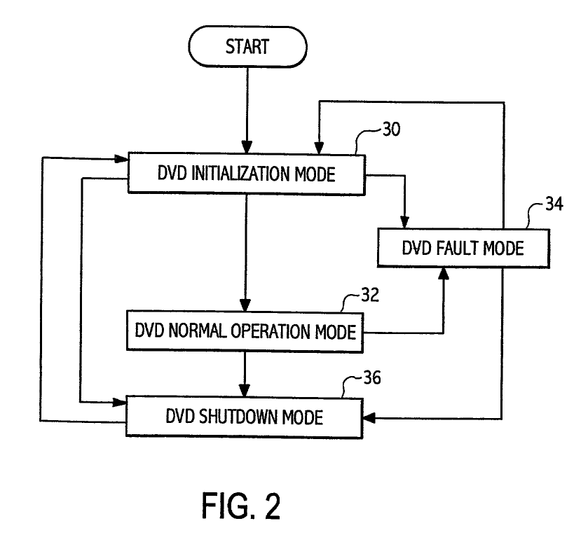

With regard to its interaction with DVD player 22, the head unit 12 controls the DVD player 22 in four principal modes of operation. These modes of operation include a DVD initialization mode 30, a DVD normal operation mode 32, a DVD fault mode 34, and a DVD shutdown mode 36. The relationship between these modes of operation is illustrated in FIG. 2. The head unit 12 preferably enters the DVD initialization mode 30 only once after the ignition is turned on. If the DVD initialization mode 30 is not properly completed, the head unit 12 will enter the DVD shutdown mode 36 until the vehicle ignition is turned off and once again turned on. After the DVD initialization mode 30 is properly completed, the head unit 12 enters the DVD normal operation mode 32. In the DVD normal operation mode 32, the DVD player 22 can execute valid commands from the head unit 12. The head unit 12 can enter the DVD shutdown mode 36 by a shutdown request from each of the other DVD modes. For example, if the vehicle ignition is turned off, the head unit 12 will enter the DVD shutdown mode 36. The head unit 12 can also enter the DVD shutdown mode 36 when a critical error occurs and the head unit 12 determines that shutdown is appropriate. The head unit 12 will enter DVD fault mode 34 whenever a fault is detected. If the head unit 12 enters the DVD shutdown mode 36 from the DVD initialization mode 30, it either indicates that the DVD initialization mode 30 could not be properly completed or that the ignition has been turned off. In the DVD shutdown mode 36, all functions of the head unit 12 related to the DVD player 22 are disabled. Lastly, the head unit 12 can change from the DVD shutdown mode 36 to the DVD initialization mode 30 when the vehicle ignition is turned on during the DVD shutdown mode 36.

The head unit 12 monitors the DVD player 22 periodically to determine whether a functional fault exists. All the DVD player fault conditions will cause the head unit 12 to change to the DVD fault mode 34. The head unit 12 processes the faults differently depending on the severity of the fault. All critical faults from the DVD player 22 will cause the head unit 12 to enter the DVD shutdown mode 36. Critical faults prevent the DVD player 22 from being operated. Critical faults may include, for example, a power supply fault, a focus fault, a thermal shutdown fault, and a driver error fault. Critical faults should be logged in the head unit 12 for diagnostic purposes. If a critical fault exists, the DVD player 22 will not be available to the user when the user depresses buttons on the bezel of the head unit 12 or the rear seat controller 14 that relate to the operation of the DVD player 22. As for non-critical faults, the head unit 12 does not need to re-enter the DVD initialization mode 30. Non-critical faults do not prevent the DVD player 22 from being operated. Such faults include, for example, a bad disk fault, a bad sector fault, or some other fault that may interfere with the ability of the DVD player to read the video disk.

The head unit 12 periodically monitors the DVD player node on its internal communication network (not shown), whether the DVD player is active or not. This ensures that the integrity of the communication link between the head unit 12 and the DVD player 22 is not compromised and that the DVD player 22 operates as expected by the head unit 12.

Preferably, one message is created to achieve the monitoring and fault reporting functions. This message could be used to establish an in-vehicle entertainment system heartbeat. The heartbeat could be established at a specified rate (e.g., a rate of specified seconds). The rate could be adjusted easily according to a particular entertainment system design and performance requirements. The integrity of the communication link between the head unit 12 and the DVD player 22 and the fault status of the DVD player 22 could be reported back to the head unit 12 at the specified rate.

The head unit 12 should interrogate the DVD player 22 to confirm the existence of a communication failure or a fault message. That is to say, if a communication failure or fault message is detected, there should be a predetermined number of re-tries (e.g., three re-tries). The re-tries are preferably performed at a specified rate (e.g., at millisecond intervals). If the communication failure or a critical fault message is confirmed following the predetermined number of re-tries, the heartbeat will be terminated until a DVD initialization mode 30 is successfully completed.

Now, the method for interfacing the head unit 12 and the DVD player 22 will be described in greater detail. Every time the vehicle ignition is turned on, the head unit 12 enters the DVD initialization mode 30. The DVD initialization mode 30 is preferably initiated only once each time the ignition is turned on to reduce bus traffic in the internal network of the head unit 12.

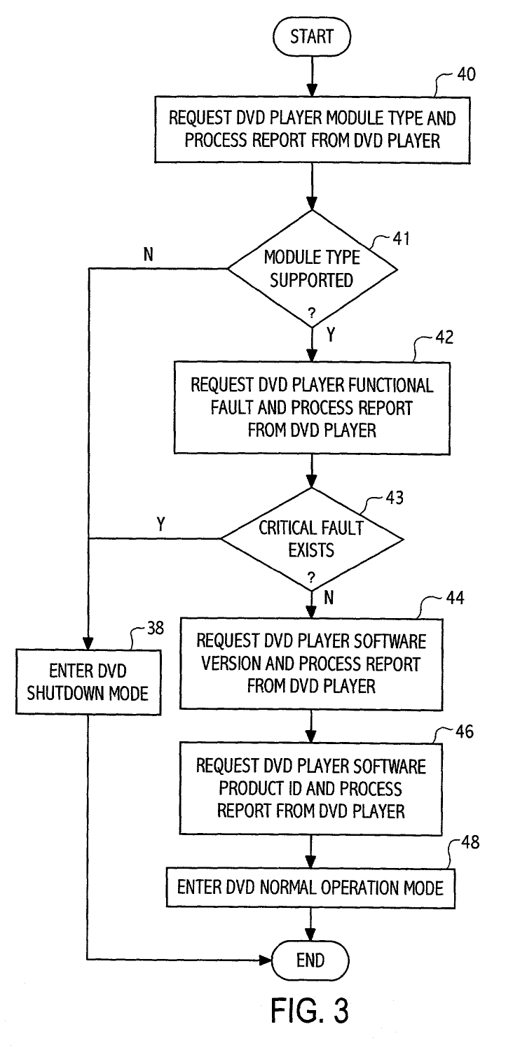

The DVD initialization mode 30 is performed by executing four messages in sequential order. A flowchart of a method for performing the DVD initialization mode 30 is illustrated in FIG. 3. In an initial step 40 of the method, the head unit 12 requests the module type of the DVD player 22 present in the network and waits for a report back from the DVD player 22. If a DVD player 22 is not present in the network, then no response or report will be received to the request message and, after the expiration of a predetermined number of retries, the head unit 12 enters the DVD shutdown mode 38, as indicated in step 38. If the head unit 12 is unable to communicate with the DVD player 22 or the DVD player 22 does not report back to the head unit 12, then head unit 12 functions as if no DVD player 22 exists in the in-vehicle entertainment system 10 and enters the DVD shutdown mode 38. If the module type of the DVD player 22 is reported back to the head unit 12, the head unit 12 determines if the module type is one supported by the head unit 12, as indicated in step 41. If the module type of the DVD player 22 is one that is unsupported by the head unit 12, then head unit 12 enters the DVD shutdown mode, as indicated in step 38.

If a report is returned to the head unit 12 about the module type of DVD player 22 and the module type is one that is supported by the head unit 12, then the head unit 12 determines if the DVD player 22 could be set up in a normal operating condition. This is accomplished by sending a multiplex message requesting DVD functional faults and waiting for a report from the DVD player 22, as indicated in step 42, and determining if a fault exists, as indicated in step 43. If a functional fault message is reported to the head unit 12, the head unit 12 enters the DVD fault mode 34. In the fault mode 34, the head unit 12 interrogates the DVD player 22 a predetermine number of times or retries. If, after a predetermined number of re-tries, a critical functional fault is confirmed, the head unit 12 enters DVD shutdown mode 36, as indicated in step 38. The head unit 12 reports the fault and disables all functions by the head unit 12 related to the DVD player 22 until the fault is cleared. This is to make sure that any previous fault is cleared before entering the normal operation mode 32. A detailed description of a method for processing faults is provided hereinbelow.

If no functional fault is reported from the DVD player 22 to the head unit 12, then the head unit 12 requests the software version of the DVD player 22 and the software product identification of the DVD player 22 and waits for reports from the DVD player 22, as indicated in steps 44 and 46. This information is used by a system diagnostic component of the head unit 12. This information is also used by the head unit 12 to set up a normal operating environment for the DVD player 22. This information is requested only if the module type of the DVD player 22 is one that is supported by the head unit 12 and a functional fault message is not reported to the head unit 12 from the DVD player 22.

During the DVD initialization mode 30, the head unit 12 obtains information about the DVD player 22 necessary to set up a normal operating environment for DVD player 22 in the vehicle entertainment system 10. After completing steps 44 and 46, the head unit 12 enters the DVD normal operation mode 32, as indicated in step 48.

In the DVD normal operation mode 32, the head unit 12 communicates with the DVD player 22 with only two messages. These include a message corresponding to the request for DVD functional faults (i.e., the heartbeat message) and a message corresponding to either a request for the operation status of the DVD player 22 or a command to be executed by the DVD player 22.

It should be noted that the head unit 12 uses six separate messages to perform all its communications with the DVD player 22. These include requests for the module type, functional faults, software version, software product identification, operation status of the DVD player 22, and commands to the DVD player 22. The first four messages are communicated in sequential order during the DVD initialization mode 30. Only two messages (i.e., requests for function faults and requests for status from, or commands to, the DVD player 22) are communicated during the DVD normal operation mode 32. By creating and using a very limited number of messages, network traffic is minimized without sacrificing the performance of the entertainment system 10. The resultant entertain system 10 is concise, robust, and runs in optimal condition.

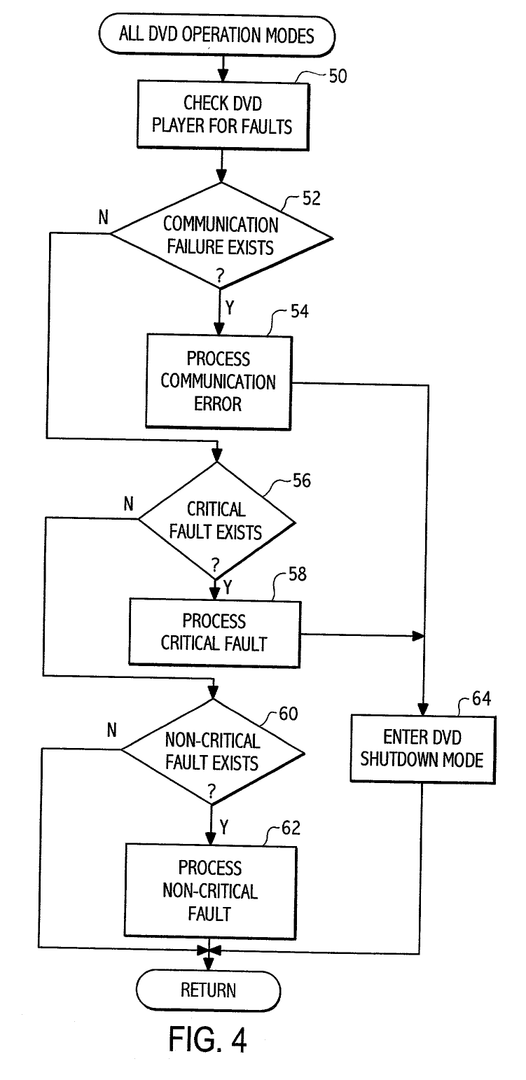

A method for processing the faults is illustrated in FIG. 4. The head unit 12 checks for functional faults during every mode of operation, as indicated in step 50. The head unit 12 checks the DVD player 22 for faults at a specified rate. During a fault check, the head unit 12 determines whether a communication could be established between the head unit 12 and the DVD player 22, as indicated in step 52. If communication cannot be established, then a communication error is processed (after the specified number of retries), as indicated in step 54.

If communication between the head unit 12 and the DVD player 22 is established, then the head unit 12 determines whether a critical fault exists, as indicated in step 56. Critical faults cause the DVD player 22 to be non-operable. Such faults may include, for example, a power supply fault, a focus fault, a thermal shutdown fault, and a driver error fault. If a critical fault exists (after the specified number of retries), then the critical fault is processed, as indicated in step 58.

If no communication failure or critical error exists, then the head unit 12 determines whether a non-critical fault exists, as indicated in step 60. Non-critical faults are those faults that do not prevent the DVD player 22 from operating. If a non-critical fault exists (after the specified number of retries), then the non-critical fault is processed, as indicated in step 62. Non-critical errors faults include, for example, a bad disk fault, a bad sector fault, or some other fault associated with the ability of the DVD player 22 to read a video disk.

As stated above, the manner in which faults are processed depends on the severity of the faults. If a communication failure or critical fault exists after the specified number of retries, then the head unit 12 enters the DVD shutdown mode 36, as indicated in step 64. All functions of the head unit 12 related to the DVD player 22 are disabled. The head unit 12 can change from the DVD shutdown mode 36 to the DVD initialization mode 30 only when the vehicle ignition is turned off and once again turned on. Unlike a communication failures or critical faults, non-critical faults permit a user to re-enter the DVD operation modes later (i.e., after the non-critical fault has been cleared).

The user will be informed of faults by messages displayed on the display 24 of the head unit 12. Communication failures or critical faults will display a message, such as “SERVICE DVD”. Non-critical faults will display a message, such as “DVD ERROR #n”, wherein “n” represents some value corresponding to a particular non-critical error, or a message, such as, for example, “DATA DISC”, “SURFACE ERROR”, “INVALID MEDIA TYPE”, “FOCUS ERROR”, and “TRACK NOT AVAILABLE”.

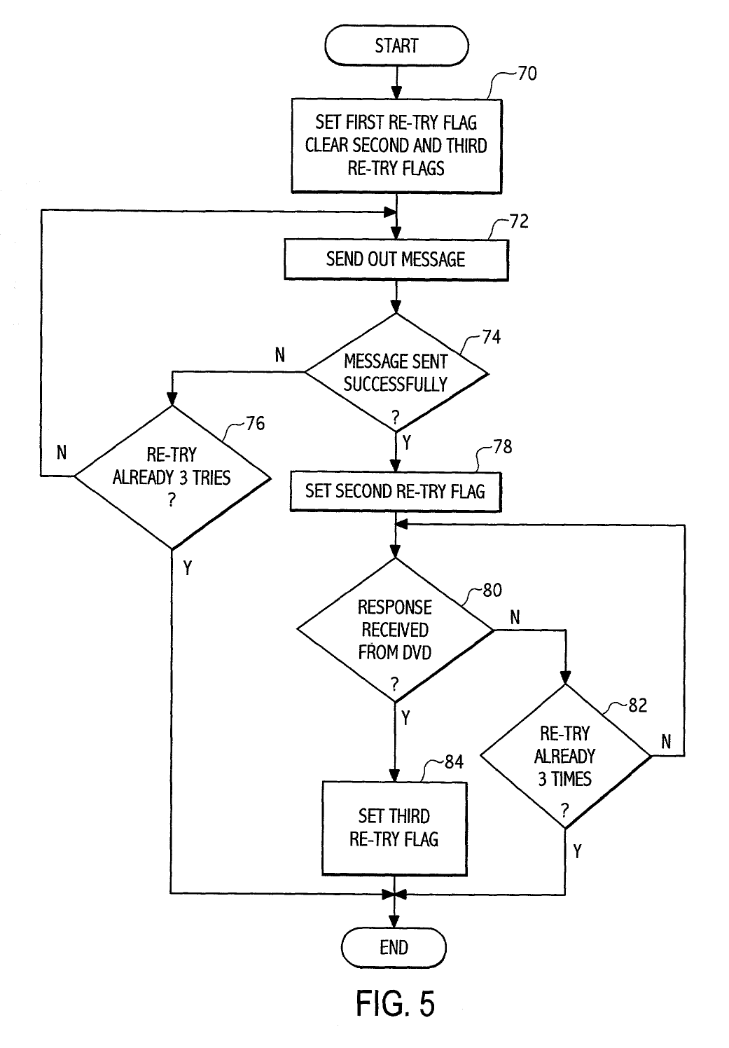

As stated above, a predetermined number of retries are carried out before entering the DVD shutdown mode 36. The retries are performed by the head unit 12 during the DVD fault mode 34. A method for processing retires is illustrated in FIG. 5. The method could be controlled by using three flags.

A first re-try flag could be set prior to each transmit attempt, as indicated in step 70. The first re-try flag corresponds to the desired communication message to be updated. After the first flag is set, the message is communicated, as indicated in step 72. The head unit 12 then determines if the message is sent successfully, as indicated in step 74. If, after a predetermined number of attempts (e.g., three attempts), as indicated in step 76, the message has not been successfully sent, the head unit 12 enters the DVD shutdown mode 36.

If the message has been successfully sent, a second re-try flag is set to indicate that the head unit 12 is waiting to receive a response back from the DVD player 22 to the aforementioned message, as indicated in step 78. After the second flag is set, the head unit 12 then determines if the response has been successfully received from the DVD player 22, as indicated in step 80. If, after a predetermined number of attempts (e.g., three attempts), as indicated in step 82, the response message has not been successfully received, the head unit 12 enters the DVD shutdown mode 36.

If the response message has been successfully received, a third and final re-try flag is set in the corresponding message receiving function, as indicated in step 84. It indicates that the head unit 12 has received an expected response from the DVD player 22.

Prior to sending out another message, the first re-try flag is set and the second and third re-try flags are cleared, as indicated in step 70. This strategy could be applied in any network used in the entertainment system 10.

This interrogation strategy increases the robustness and effectiveness of the entertainment system 10 and reduces the effects of interference and noise existing in the vehicle and surrounding environment.

All command messages from the head unit 12 to the DVD player 22 could be processed by a single software function or routine. The DVD normal operation mode 32 is set up following the DVD initialization mode 36. Command messages from the head unit 12 could be processed to the DVD player 22 when the head unit 12 is in the DVD normal operation mode 32.

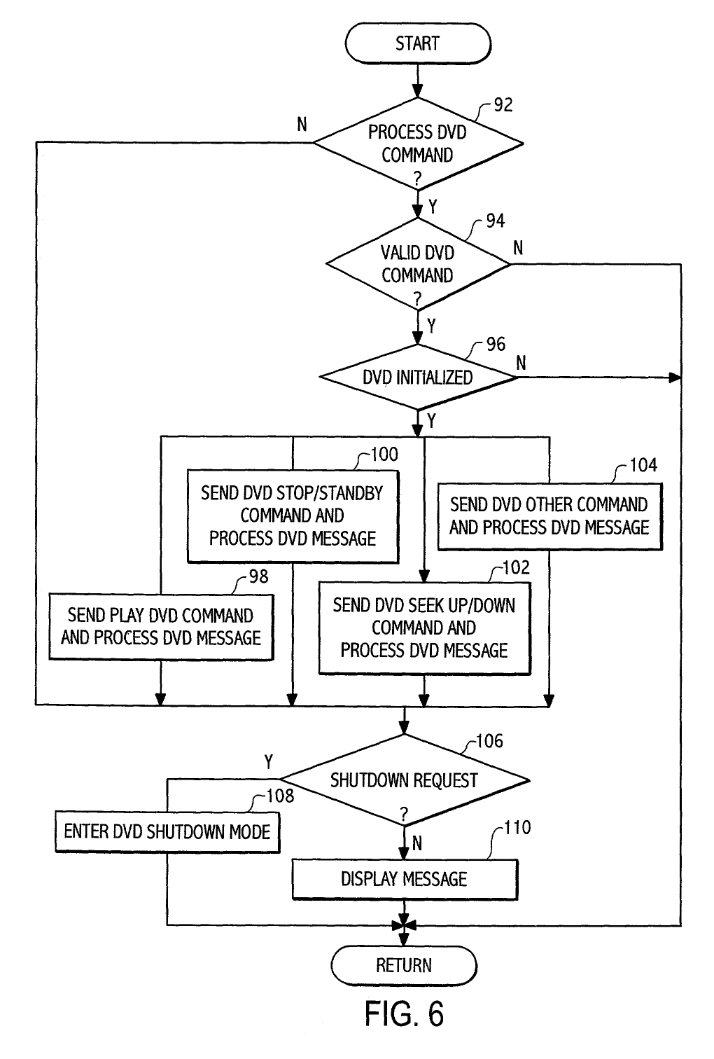

A method for processing commands is illustrated in FIG. 6. The method includes an initial step 92 of determining whether the head unit 12 needs to process a command to the DVD player 22. If a command needs to be processed, the head unit 12 determines if the command is valid, as indicated in step 94. If the command is valid, the head unit 12 then checks to insure that the DVD initialization mode 36 has been properly completed, as indicated in step 96. If the command is not valid or the DVD initialization mode 36 has not been properly completed, then the command is not processed. If the command is valid and the DVD initialization mode 36 is properly completed, then the command is processed.

Examples of valid commands are illustrated in the drawing. These commands include DVD playback or play command, DVD stop or standby, DVD seek up or down, and other valid commands, which are indicated at steps 98, 100, 102, and 104, respectively. In each one of these steps, the command is sent from the head unit 12 to the DVD player 22 and a corresponding message is processed by the head unit 12 from the DVD player 22.

The messages received by the head unit 12 from the DVD player 22 can confirm that the DVD player 22 has received the commands. The messages can also provide information relating to the status of the DVD player 22. Text string display messages can even be processed and displayed on the display 24, as indicated at step 110. It should be appreciated that such messages could be displayed by any conventional method that does not affect the operation of other components in the entertainment system 10.

If, in step 92, the head unit 12 determines that no commands need to be processed, steps 94 through 104 are skipped. If a request for shutdown is received (e.g., the ignition is turned off), as indicated in step 106, the head unit 12 enters the DVD shutdown mode 36, as indicated at step 108.

The interface method according to the present invention establishes communication between the head unit 12 and the DVD player 22 efficiently and thereby minimizes bus traffic to the internal network of the head unit 12. One manner in which this is accomplished is by initiating the DVD initialization mode 30 only once each time the ignition is turned on. If the DVD initialization mode 30 is not properly completed, the head unit 12 enters the DVD shutdown mode 36. This is also accomplished by using few messages (e.g., as few as two messages) to accomplished all communication between the head unit 12 and the DVD player 22 during the normal operation mode 32. This is further accomplished by using one of the communication messages periodically (e.g., as a heartbeat) to detect communication failures and faults. The periodic rate could be adjusted according to the entertainment system 10 and performance requirements.

Another key feature of the interface design relates to its handling of faults associated with the DVD player 22. The re-try strategy avoids detection of false faults and is less likely to be influenced by noise or other interference in the entertainment system 10.

While this invention has been described with respect to several preferred embodiments, various modifications and additions will become apparent to person of ordinary skill in the art. All such variations, modifications, and variations are intended to be encompassed within the scope of this patent, which is limited only by the claims appended hereto.

What is claimed is:

1. An in-vehicle entertainment system, comprising:
a head unit; and
a DVD player integrated with said head unit and remote from said head unit.

2. The system according to claim 1, wherein said head unit comprises a display for user interaction.

3. The system according to claim 1, wherein said head unit comprises an audio processor for generating audio output signals for reproduction by said entertainment system.

4. The system according to claim 1, wherein said head unit is connected to said DVD player through a multiplex network.

5. The system according to claim 1, wherein said head unit has four principal modes of operation, including:
a DVD initialization mode wherein said head unit communicates with said DVD player to gather information to set up said DVD player for normal operation;
a DVD normal operation mode wherein said head unit communicates with said DVD player to request operation status from said DVD player and load valid commands to said DVD player for excution by said DVD player;
a DVD shutdown mode wherein operation modes of said head unit related to said DVD player are disabled, said head unit further periodically monitoring said DVD player to ensure that communication between said head unit and said DVD player is not compromised and that no functional faults are detected; and
a DVD fault mode wherein said head unit processes communication failures and DVD player functional faults.

6. The system according to claim 5, wherein said head unit enters the DVD initialization mode only once after the vehicle ignition is turned on.

7. The system according to claim 5, wherein said head unit enters the DVD shutdown mode if the DVD initialization mode is not properly completed.

8. The system according to claim 5, wherein said head unit enters the DVD shutdown mode when a critical error occurs.

9. The system according to claim 5, wherein said head unit enters the DVD shutdown mode if the vehicle ignition is turned off.

10. The system according to claim 5, wherein one message is used to monitor said DVD player and report faults from said DVD player to said head unit.

11. The system according to claim 10, wherein the message is used to establish an in-vehicle entertainment system heartbeat at a specified rate.

12. The system according to claim 5, wherein said head unit interrogates said DVD player in the DVD fault mode to confirm existence of a communication failure or a fault message.

13. The system according to claim 12, wherein the heartbeat is terminated if t he existence of a communication failure or critical fault message is confirmed.

14. A method for interfacing a head unit integrated with a DVD player in an in-vehicle entertainment system, comprising the step of:
a) initializing the DVD player;
b) monitoring the DVD player for communication failures and functional faults;
c) entering a normal operation mode if the DVD player is initialized and no communication failures or functional faults exist;
d) entering a fault mode if a communication failure or critical functional fault exists; and
e) shutting down the DVD player if a communication failure or functional fault is confirmed.

15. The method according to claim 14, wherein step a) is performed when a vehicle ignition is turned on.

16. The method according to claim 14, wherein step a) further comprises the steps of:
i) requesting a module type from the DVD player;
ii) determining if communications failure or functional faults exists;
iii) requesting a software version from the DVD player; and
iv) requesting a software product identification from the DVD software component.

17. The method according to claim 14, wherein step b) is performed at a specified rate.

18. The method according to claim 14, wherein step c) further comprises the step of communicating with DVD player with only two messages by requesting DVD functional faults and either requesting the operation status of the DVD player or loading a command to the DVD player.

19. The method according to claim 14, wherein step d) comprises the steps of:
i) setting first re-try flag prior to transmitting message from the head unit to the DVD player;
ii) setting a second re-try flag to indicate that the head unit is waiting to receive a response back from the DVD player to the message transmitted in step i) of step d); and
iii) setting a third re-try flag to indicate that the head unit has received a response from the DVD player.
